(19) United States
(12) Patent Application Publication
(10) Pub. No.: US 2021/0059264 A1
(43) Pub. Date: Mar. 4, 2021

(54) USE OF ORGANIC ACIDS IN ARTISAN BREAD PRODUCTION

(71) Applicant: Bartek Ingredients Inc, Stoney Creek (CA)

(72) Inventors: Jayne Erin Bock, Portland, OR (US); Alejandro Jose Perez Gonzalez, Zapopan (MX); Jeff Billig, Lincoln University, PA (US); Milad Moshfeghian, Etobicoke (CA)

(21) Appl. No.: 17/006,252

(22) Filed: Aug. 28, 2020

Related U.S. Application Data
(60) Provisional application No. 62/893,858, filed on Aug. 30, 2019.

(51) Int. Cl. A21D 2/14; A21D 13/047

(52) U.S. Cl. CPC A21D 2/145; A21D 13/047

(57) ABSTRACT

The present disclosure relates to a method of artisan bread production. In particular, the present disclosure provides methods for producing artisan breads with improved dough rheology (consistency), increased volume, porosity, textural shelf life, aroma and flavor, while maintaining a more uniform and aesthetically-pleasing shape with the use of organic acids and non-wheat flour.

### CROSS REFERENCE TO PRIOR APPLICATIONS

This application claims priority to U.S. provisional patent application no. 62/893,858 filed Aug. 30, 2019 and entitled “USE OF ORGANIC ACIDS IN ARTISAN BREAD PRODUCTION”, the contents of which is incorporated herein by reference in its entirety.

### FIELD OF THE DISCLOSURE

The present disclosure relates generally to the use of organic acids and non-wheat flour as a dough additive in artisan breads. The present disclosure may be used to improve various characteristics of artisan breads, including volume, porosity of crumb structure, textural shelf life, flavor and aroma, and external visual appearance.

### BACKGROUND OF THE INVENTION

Organic acids such as fumaric acid, acetic acid, citric acid, lactic acid and malic acid, have been used as ingredients or additives in bakery products for their desirable qualities such as extended shelf life, increased porosity of bread, and reduction in the mixing requirement in the development of bakery products.

Among many organic acids, fumaric acid in particular has been used in certain bakery applications, including in yeast leavened dough products such as English muffins, and in non-yeast leavened applications such as tortillas. Organic acids act as a preservative and can improve the shelf-life of bakery products. However, the use of organic acids in artisan bread has not been explored due to production methods and more traditional formulations used to bake these specialized breads.

Further, the use of organic acids in artisan bread to modify certain dough properties has been limited. In general, traditionally an ideal bread dough has a balanced dough rheology, meaning that it has both elastic and extensible properties. Also, the ability to increase dough strength (i.e. make the dough more elastic) can have advantages in the industrial adoption of artisan breads, as it imparts robustness to the dough against excessive handling and abuse inherent to modern industrial and automated processes. Dough rheology is affected by a variety of factors such as the protein content and quality of the wheat flour used, dough absorption (i.e., the amount of water added), dough mixing time (i.e., the length of mixing applied to obtain a developed dough) and the additives used. For instance, additives typically called “relaxers,” including L-cysteine and sodium metabisulfite are normally used when the goal is to increase dough extensibility and decrease dough mixing time, with the purpose for example, of increasing production speed. In contrast, ascorbic acid is a common dough strengthener or “oxidizing agent”, which increases the elasticity of the dough. The effectiveness of organic acids, in particular fumaric acid, in modifying dough rheology has not been a focus for the artisan bakers.

Artisan breads are distinct from mass produced bread products produced from industrial bakeries that rely on highly automated machinery and high throughput mechanisms. Artisan breads are generally made in small batches by hand using longer and more traditional bakery processes and are often associated with the use of minimal ingredients. The use of minimal chemical additives is a hallmark of artisan breads and distinguishes these breads from mass produced products. Despite the use of minimal ingredients, artisan breads do not compromise on its quality, shape, size, look, flavor, aroma and texture of the bread.

Organic acids have been used as ingredients in breads and have been shown to increase the specific volume of breads and decrease crumb firmness (Su et al., Food Chemistry 278 (2019) 267-275). While the use of organic acids in artisan breads may also increase the bread volume and reduce crumb firmness, the addition of organic acids to artisan breads may have an unwanted effect of decreased uniformity in the overall shape of the artisan bread, making the breads undesirable to the consumer. For this reason, the use of organic acids in artisan breads has been limited.

There has been an effort to produce artisan breads on a more industrial scale using modern manufacturing processes, which would result in higher yields of the bread products. However, this has many challenges as it is difficult to replicate small scale production of artisan breads in an industrial scale.

A cost-effective dough additive comprising a combination of ingredients that can improve characteristics such as dough rheology, bread volume, porosity, flavor and aroma, and textural shelf life, without compromising the quality of the finished bread product, while allowing the production of artisan breads using a modern manufacturing process in an industrial scale would be greatly beneficial to those in the artisan bread industry.

The present disclosure describes how the use of a dough additive comprising organic acids and non-wheat flour in artisan breads produced on an industrial scale can maintain desirable qualities of artisan breads, such as enhanced porosity, increased volume, increased textural shelf stability, and uniform and aesthetically-pleasing shape of the bread while using minimal and clean label ingredients.

### SUMMARY OF THE INVENTION

The present disclosure describes use of a dough additive comprising organic acids in combination with non-wheat flour in the production of artisan bread on an industrial scale, which surprisingly results in improved dough rheology, increased volume and porosity, longer textural shelf life, improved flavor and aroma, and more uniform and aesthetically-pleasing shape. The artisan bread dough prepared using organic acids and non-wheat flour also results in lowered mixing time requirement and increased dough absorption.

According to some embodiments, the artisan bread is a ciabatta bread, a baguette bread, a bolillo bread, a batard bread, a boule bread, a bagel, a stollen bread, a fougasse bread, a focaccia bread, a sourdough bread, a rye bread, a pumpernickel bread, a white bread, a multigrain bread, a panettone bread, a challah bread or a brioche bread.

According to some embodiments, the amount of organic acid is in the range of 0.05% flour weight basis (“fwb”) to 3% fwb and the amount of non-wheat flour is 0.1% fwb to 5% fwb.

According to some embodiments, the organic acid is fumaric acid, acetic acid, citric acid, lactic acid, malic acid, phosphoric acid, sorbic acid, ascorbic acid, adipic acid, gluconic acid, glucono delta-lactone or tartaric acid.

According to some embodiments, the organic acid is fumaric acid.

According to some embodiments, the non-wheat flour is rice flour, corn flour, tapioca flour, potato flour, buckwheat flour, amaranth flour, chickpea flour, oat flour, almond flour, rye flour, spelt flour, coconut flour, teff flour, millet flour, faba bean flour, pea flour, sorghum flour, quinoa flour, barley flour, almond flour, peanut flour, arrowroot flour, banana flour, sunflower seed flour, soy flour, canola flour, rapeseed flour, or flaxseed flour.

According to some embodiments, the non-wheat flour is rice flour.

According to some embodiments, using a dough additive comprising the combination of 0.125% fwb fumaric acid and 0.75% fwb rice flour results in improved dough rheology, increased volume and porosity, longer textural shelf life, improved flavor and aroma, and more uniform and aesthetically-pleasing shape when compared to the use of fumaric acid alone as an additive to increase volume. The artisan bread dough prepared using the combination of 0.125% fwb fumaric acid and 0.75% fwb rice flour also results in lowered mixing time requirement and increased dough absorption.

According to some embodiments, using a dough additive comprising the combination of 0.25% fwb fumaric acid and 0.50% fwb rice flour results in improved dough rheology, increased volume and porosity, longer textural shelf life, improved flavor and aroma, and more uniform and aesthetically-pleasing shape when compared to the use of fumaric acid alone as an additive to increase volume. The artisan bread dough prepared using the combination of 0.25% fwb fumaric acid and 0.50% fwb rice flour also results in lowered mixing time requirement and increased dough absorption.

According to some embodiments, the artisan bread is produced using a preferment process.

According to some embodiments, the artisan bread is produced using a straight-dough process.

### BRIEF DESCRIPTION OF THE DRAWINGS

The foregoing and other aspects of the invention will become more apparent from the following description of specific embodiments thereof and the accompanying drawings that illustrate, by way of example only, the principles of the invention.

FIG. 1A illustrates the exterior image of ciabatta bread baked using a preferment protocol without the use of an organic acid and a non-wheat flour.

FIG. 1B illustrates the horizontal slice of ciabatta bread baked using a preferment protocol without the use of an organic acid and a non-wheat flour.

FIG. 1C illustrates the exterior image of ciabatta bread baked using a preferment protocol with 0.50% fwb rice flour.

FIG. 1D illustrates the horizontal slice of ciabatta bread baked using a preferment protocol with 0.50% fwb rice flour.

FIG. 1E illustrates the exterior image of ciabatta bread baked using a preferment protocol with 0.25% fwb fumaric acid.

FIG. 1F illustrates the horizontal slice of ciabatta bread baked using a preferment protocol with 0.25% fwb fumaric acid.

FIG. 1G illustrates the exterior image of ciabatta bread baked using a preferment protocol with 0.75% fwb rice flour and 0.125% fwb fumaric acid.

FIG. 1H illustrates the horizontal slice of ciabatta bread baked using a preferment protocol with 0.75% fwb rice flour and 0.125% fwb fumaric acid.

FIG. 1I illustrates the exterior image of ciabatta bread baked using a preferment protocol with 0.50% fwb rice flour and 0.25% fwb fumaric acid.

FIG. 1J illustrates the horizontal slice of ciabatta bread baked using a preferment protocol with 0.50% fwb rice flour and 0.25% fwb fumaric acid.

FIG. 2A illustrates the exterior image of baguette bread baked using a preferment protocol without the use of an organic acid and a non-wheat flour.

FIG. 2B illustrates the horizontal slice of baguette bread baked using a preferment protocol without the use of an organic acid and a non-wheat flour.

FIG. 2C illustrates the exterior image of baguette bread baked using a preferment protocol with 0.50% fwb rice flour.

FIG. 2D illustrates the horizontal slice of baguette bread baked using a preferment protocol with 0.50% fwb rice flour.

FIG. 2E illustrates the exterior image of baguette bread baked using a preferment protocol with 0.25% fwb fumaric acid.

FIG. 2F illustrates the horizontal slice of baguette bread baked using a preferment protocol with 0.25% fwb fumaric acid.

FIG. 2G illustrates the exterior image of baguette bread baked using a preferment protocol with 0.75% fwb rice flour and 0.125% fwb fumaric acid.

FIG. 2H illustrates the horizontal slice of baguette bread baked using a preferment protocol with 0.75% fwb rice flour and 0.125% fwb fumaric acid.

FIG. 2I illustrates the exterior image of baguette bread baked using a preferment protocol with 0.50% fwb rice flour and 0.25% fwb fumaric acid.

FIG. 2J illustrates the horizontal slice of baguette bread baked using a preferment protocol with 0.50% fwb rice flour and 0.25% fwb fumaric acid.

FIG. 3A illustrates the horizontal slice of ciabatta bread baked using a straight-dough protocol without the use of an organic acid and a non-wheat flour.

FIG. 3B illustrates the exterior image of ciabatta bread baked using a straight-dough protocol without the use of an organic acid and a non-wheat flour.

FIG. 3C illustrates the horizontal slice of ciabatta bread baked using a straight-dough protocol with 0.50% fwb rice flour and 0.25% fwb fumaric acid.

FIG. 3D illustrates the exterior image of ciabatta bread baked using a straight-dough protocol with 0.50% fwb rice flour and 0.25% fwb fumaric acid.

FIG. 4A illustrates the horizontal slice of ciabatta bread baked using a straight-dough protocol without the use of an organic acid and a non-wheat flour, with a 75% absorption and a mix time of 8 minutes.

FIG. 4B illustrates the exterior image of ciabatta bread baked using a straight-dough protocol without the use of an organic acid and a non-wheat flour, with a 75% absorption and a mix time of 8 minutes.

FIG. 4C illustrates the horizontal slice of ciabatta bread baked using a straight-dough protocol with 0.125% fwb rice flour and 0.75% fwb fumaric acid, with a 78% absorption and a mix time of 8 minutes.

FIG. 4D illustrates the exterior image of ciabatta bread baked using a straight-dough protocol with 0.125% fwb rice flour and 0.75% fwb fumaric acid, with a 78% absorption and a mix time of 8 minutes.

FIG. 4E illustrates the horizontal slice of ciabatta bread baked using a straight-dough protocol with 0.25% fwb rice flour and 0.50% fwb fumaric acid, with a 78% absorption and a mix time of 8 minutes.

FIG. 4F illustrates the exterior image of ciabatta bread baked using a straight-dough protocol with 0.25% fwb rice flour and 0.50% fwb fumaric acid, with a 78% absorption and a mix time of 8 minutes.

FIG. 4G illustrates the horizontal slice of ciabatta bread baked using a straight-dough protocol with 0.25% fwb rice flour and 0.50% fwb fumaric acid, with a 78% absorption and a mix time of 5 minutes.

FIG. 4H illustrates the exterior image of ciabatta bread baked using a straight-dough protocol with 0.25% fwb rice flour and 0.50% fwb fumaric acid, with a 78% absorption and a mix time of 5 minutes.

FIG. 5A illustrates the horizontal slice of ciabatta bread baked using a preferment protocol without the use of an organic acid and a non-wheat flour.

FIG. 5B illustrates the exterior image of ciabatta bread baked using a preferment protocol without the use of an organic acid and a non-wheat flour.

FIG. 5C illustrates the horizontal slice of ciabatta bread baked using a preferment protocol with 0.50% fwb rice flour and 0.25% fwb fumaric acid.

FIG. 5D illustrates the exterior image of ciabatta bread baked using a preferment protocol with 0.50% fwb rice flour and 0.25% fwb fumaric acid.

FIG. 5E illustrates the mean Peak Force of ciabatta bread baked using a preferment protocol with 0.50% fwb rice flour and 0.25% fwb fumaric acid as compared to a control.

FIG. 6A illustrates the horizontal slice of baguette bread baked using a preferment protocol without the use of an organic acid and a non-wheat flour.

FIG. 6B illustrates the exterior image of baguette bread baked using a preferment protocol without the use of an organic acid and a non-wheat flour.

FIG. 6C illustrates the horizontal slice of baguette bread baked using a preferment protocol with 0.50% fwb rice flour and 0.25% fwb fumaric acid.

FIG. 6D illustrates the exterior image of baguette bread baked using a preferment protocol with 0.50% fwb rice flour and 0.25% fwb fumaric acid.

FIG. 7A illustrates the horizontal slice of ciabatta bread baked using a preferment protocol without the use of an organic acid and a non-wheat flour.

FIG. 7B illustrates the exterior image of ciabatta bread baked using a preferment protocol without the use of an organic acid and a non-wheat flour.

FIG. 7C illustrates the horizontal slice of ciabatta bread baked using a preferment protocol with 0.725% fwb rice flour and 0.125% fwb fumaric acid.

FIG. 7D illustrates the exterior image of ciabatta bread baked using a preferment protocol with 0.725% fwb rice flour and 0.125% fwb fumaric acid.

FIG. 7E illustrates the mean Peak Force of ciabatta bread baked using a preferment protocol with 0.725% fwb rice flour and 0.125% fwb fumaric acid as compared to a control.

Other features and advantages of the present disclosure will become more apparent from the following detailed description and from the exemplary embodiments.

### DETAILED DESCRIPTION OF THE INVENTION

It will be appreciated that numerous specific details have been provided for a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered so that it may limit the scope of the embodiments described herein in any way, but rather as merely describing the implementation of the various embodiments described herein.

The description that follows, and the embodiments described therein, are provided by way of illustration of an example, or examples, of particular embodiments of the principles of the present invention. These examples are provided for the purposes of explanation, and not limitation, of those principles and of the invention.

The terminology used herein is for the purpose of describing particular embodiments only and is not intended to be limiting of example embodiments of the invention. Unless defined otherwise, all technical and scientific terms used herein generally have the same meaning as commonly understood by one of ordinary skill in the art to which this disclosure belongs.

As used herein, the singular forms “a,” “an,” and “the”, are intended to include the plural forms as well, unless the context clearly indicates otherwise.

The phrase “and/or” should be understood to mean “either or both” of the elements so conjoined, i.e., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

When a range of values is listed herein, it is intended to encompass each value and sub-range within that range. For example, “0.1-1.5% fwb flour weight basis (“fwb”)” is intended to encompass 0.1, 0.2, 0.3, 0.4, 0.5, etc. % fwb and up to 1.5, 1.4, 1.3, 1.2, 1.1, 1.0, etc. % fwb.

It will be further understood that the terms “comprises,” “comprising,” “includes,” and/or “including”, when used herein, specify the presence of stated features, integers, steps, operations, elements, and/or components, but do not preclude the presence or addition of one or more other features, integers, steps, operations, elements, components, and/or groups thereof.

The term “effective amount” as used herein is an amount that would bring about the desired effect, based on the purpose and function of the ingredient and composition in which the ingredient is used. What constitutes an effective amount will be determinable by the person of ordinary skill in the art without having to engage in inventive experimentation. In more specific aspects, an effective amount may result in improved dough rheology, increased volume, increased porosity, longer textural shelf life, improved flavor, improved aroma, and/or a more uniform and aesthetically-pleasing shaped bread product.

This present invention is embodied in the form of uses of a dough additive comprising at least one organic acid and at least one type of non-wheat flour to obtain artisan breads with improved dough rheology, increased volume and porosity, longer textural shelf life, improved flavor and aroma, and a more uniform and aesthetically-pleasing shape. According to some embodiments, there is provided a dough additive for use in making artisan bread comprising at least one organic acid, such as fumaric acid, acetic acid, citric acid, lactic acid, malic acid, phosphoric acid, sorbic acid, ascorbic acid, adipic acid, gluconic acid, glucono delta-lactone or tartaric acid, and at least one type of non-wheat flour, such as rice flour, corn flour, tapioca flour, potato flour, buckwheat flour, amaranth flour, chickpea flour, oat flour, almond flour, rye flour, spelt flour, coconut flour, teff flour, millet flour, faba bean flour, pea flour, sorghum flour, quinoa flour, barley flour, almond flour, peanut flour, arrowroot flour, banana flour, sunflower seed flour, soy flour, canola flour, rapeseed flour, or flaxseed flour.

It is understood that artisan breads are types of breads that are typically hand-made, individually shaped with a more rustic crust and flavour that is distinguishable from mass produced bread products. Artisan bread production encompasses a traditional style of baking that emphasizes the limited number of quality ingredients, individual hand shaping of the bread dough through appropriate kneading and folding techniques, and baking in small batches. Artisan breads do not refer to a set of defined breads, but rather “artisan” refers to a manufacturing method that would be considered traditional and rudimentary, with limited use of automated machines. Artisan breads can cover broad types of breads made in this way, including but not limited to a ciabatta bread, a baguette bread, a bolillo bread, a batard bread, a boule bread, a bagel, a stollen bread, a fougasse bread, a focaccia bread, a sourdough bread, a rye bread, a pumpernickel bread, a white bread, a multigrain bread, a panettone bread, a challah bread or a brioche bread. However, there has been an effort to produce artisan breads on a more industrial scale using a modern manufacturing process, which would result in higher yields of the bread products. The use of the invention in all types of artisan breads baked in traditional style as well as modern industrial scale is contemplated and are within the scope of this application.

It is also understood that while many organic acids have been used in certain bakery applications, the use of organic acids has been limited in artisan breads due to the production methods using a typical formula or recipe of artisan breads and the effects of organic acids on artisan breads. All sources of organic acids including but not limited to fumaric acid, acetic acid, citric acid, lactic acid, malic acid, phosphoric acid, sorbic acid, ascorbic acid, adipic acid, gluconic acid, glucono delta-lactone and tartaric acid are contemplated and are within the scope of this application. Various forms of organic acids, including different formulations of the organic acids as well as encapsulated and granulated forms of organic acids are also within the scope of this application.

The present disclosure is intended to allow the addition of at least one type of organic acids in the range of 0.05% fwb to 3% fwb with at least one type of non-wheat flour in the range of 0.1% fwb to 5% fwb to produce artisan breads on an industrial scale that maintain desirable qualities such as enhanced porosity, increased volume, better taste and texture, balanced dough rheology, uniform and aesthetically-pleasing shape and longer shelf-life while using minimal quality and clean label ingredients, a key feature associated with artisan breads.

The present disclosure is also intended to allow the addition of at least one type of organic acids in the range of 0.05% fwb to 3% fwb that results in modified dough rheology, where the addition of organic acid has a similar effect to that expected of traditional relaxers by lowering the mixing time requirement.

In an embodiment of the invention, the organic acid may be fumaric acid, acetic acid, citric acid, lactic acid, malic acid, phosphoric acid, sorbic acid, ascorbic acid, adipic acid, gluconic acid, glucono delta-lactone or tartaric acid. In a preferred embodiment, the organic acid is fumaric acid.

It is understood that non-wheat flours may be used in various bread products. The use of at least one type of non-wheat flour in conjunction with at least one type of organic acids is contemplated and is within the scope of this application.

In an embodiment of the invention, the non-wheat flour may be rice flour, corn flour, tapioca flour, potato flour, buckwheat flour, amaranth flour, chickpea flour, oat flour, almond flour, rye flour, spelt flour, coconut flour, teff flour, millet flour, faba bean flour, pea flour, sorghum flour, quinoa flour, barley flour, almond flour, peanut flour, arrowroot flour, banana flour, sunflower seed flour, soy flour, canola flour, rapeseed flour, or flaxseed flour. In a preferred embodiment, the non-wheat flour is rice flour.

In an embodiment of the invention, the use of at least one type of organic acid in conjunction with at least one type of non-wheat flour is preferred. In a preferred embodiment, the organic acid is fumaric acid and the non-wheat flour is rice flour. In a more preferred embodiment, 0.125% fwb fumaric acid is used in conjunction with 0.75% fwb rice flour. In another more preferred embodiment, 0.25% fwb fumaric acid is used in conjunction with 0.50% fwb rice flour.

Artisan breads made in accordance with the present invention may be produced using various processing methods. According to some embodiments, the artisan bread may be baked using a preferment protocol. A preferment is a mixture of dough components that is mixed separately from the bread dough and is allowed to ferment on its own prior to mixing in the rest of the ingredients to make the final dough. Preferments contain different proportions of ingredients and water, and their physical character can vary from liquid to plastic. Typical components of preferments include portions of the flour, water and yeast, and its purpose includes obtaining specific baked bread characteristics, by means of developing flavors and aromas, modifying the components in the flour (e.g. protein and starch), and increasing the acidity of the dough. According to some other embodiments, the artisan bread may be baked using a straight-dough protocol, which does not include a preferment step. In such a process, all dough components are added, mixed and fermented together, with the advantage of having a shorter total process time, which is beneficial for practical reasons, for example for industrial application. Some disadvantages of straight-dough protocols compared to preferment include less flavor and aroma in the finished bread, and less acidity development in the dough.

Advantageously, artisan breads made in accordance with the present invention may be produced using any type of yeast that is typically used in commercial baking. According to some embodiments, the yeast used may be instant dry yeast. According to some other embodiments, the yeast used may be compressed yeast. According to some other embodiments, the yeast used may be active dry yeast. According to some other embodiments, the yeast used may be liquid or “cream” yeast.

Various properties of the flour and doughs, including mix time reductions were tested using Mixolab, a dough testing equipment system used to assess the baking quality and performance of hydrated cereal flour. Mixolab records rheological properties of dough subjected to mixing and temperature changes. The test undergoes five different phases:
phase I (initial mixing, hold at 86° F. or 30° C. for 8 minutes)—evaluates dough formation and weakening;
phase II (weakening, heating from 86 to 140° F., 30-60° C.)—evaluates gluten weakening as a function of torque reduction;
phase III (gelatinization, heating from 140-194° F., 60-90° C.)—evaluates starch gelatinization properties;
phase IV (stability during baking, hold at 194° F., 90° C.)—measures the hot gel stability;
phase V (retrogradation, cooling from 194 to 140° F., 90-60° C.)—evaluates starch retrogradation, which is correlated to bread staling.

At the end of the five phases, Mixolab produces a flour profiler graph and relates six factors, absorption, mixing, gluten, viscosity, amylase and retrogradation, which gives an indication or baseline for the product being tested allowing comparisons of various formulations (AACC International. Approved Methods of Analysis, 11th Ed. Method 54-40.02. Determination of Rheological Behavior as a Function of Mixing and Temperature Increase in Wheat Flour and Whole Wheat Meal by Mixolab).

Dough rheology or consistency may also be assessed informally, as can be appreciated by a person of ordinary skill in the art. For example, dough rheology was assessed informally using the scale set out in Table 1.

TABLE 1
Informal dough rheology scores

| Score | Dough characteristic | Meaning |
|---|---|---|
| 1 | Very weak | Excessively extensible, needs extra handling, may make |
| | | difficult processing dough into quality bread, regardless |
| | | of process type |
| 2 | Weak | Much more extensible than elastic, needs extra |
| | | handling, may present some difficulties to process, |
| | | especially in industrial settings |
| 3 | Slightly weak | More extensible than elastic, needs some extra |
| | | handling, may present minor difficulties to process |
| 4 | Balanced | Traditionally an ideal bread dough with both good |
| | | elasticity and extensibility, for application in a variety |
| | | of production settings to make quality bread |
| 5 | Slightly strong | More elastic than extensible, may be somewhat |
| | | beneficial against normal abuse in industrial, automated, |
| | | and high-speed processes |
| 6 | Strong | Much more elastic than extensible, may be beneficial |
| | | against normal abuse in industrial, automated, and high- |
| | | speed processes, but may make processing difficult in |
| | | some cases |
| 7 | Very strong | Excessively elastic with little extensibility, may make |
| | | difficult processing into quality bread, regardless of |
| | | process type |

Ph of the doughs or breads was measured based on the AACC method 02-52.01. Specifically, 15 g of dough or bread crumb was placed in a dry Erlenmeyer flask and 100 ml of distilled water was added. The flask was agitated until the dough or bread crumb is suspended and free of lumps. The suspension is maintained for 30 minutes with continuous stirring. The suspension is then allowed to stand and settle for 10 minutes. The supernatant liquid is decanted into an electrode vessel and the Ph is immediately determined using a potentiometer and electrodes that have been calibrated against known buffer solutions.

The bread volume was measured using the bread volume meter (BVM) (AACC International Method 10-14.01). In this method, laser topography is used to digitally model a sample and determine its volume. The method is applicable to round, elongated, and rectangular leavened bread products with volumes of 200-2,800 MI. The steps to take measurements were as follows:
1. Enter product, batch, and test information for the sample in the computer loaded with the software provided, including a test duration of at least 30 sec.
2. Insert a support shaft and plate to suit the sample's size in the instrument's chuck.
3. Mount the sample on the support plate with its long axis oriented vertically. Center the sample using the instrument guides. Lower the top shaft so that it slightly penetrates the top center of the sample to stabilize it during measurement.
4. Press “Run” to start the test. Note the sample volume in mL or cc (cm3) reported by the software when the scan is complete.

The bread specific volume was calculated for each bread by dividing the bread volume (in cc) by the weight of the bread (in grams).

The porosity or crumb structure was measured using the C-Cell model CC.400 (AACC International Method 10-18.01). The C-Cell imaging system uses image analysis software to measure crumb structure characteristics of baked products. The system takes a side-lit image of the sliced product, and crumb structure parameters are determined using software algorithms, producing 59 different numerical results (variables), from which users select those most applicable to the baked product being evaluated and type of information desired. The steps to take measurements were as follows:
1. Slice the baked product.
2. Place the baked product slice in the center of the sample tray with the surface for analysis facing upward.
3. Close the drawer slowly.
4. Analyze the image using the software as follows:
   a. In the Main Window select a Product from the drop-down menu.
   b. Select Live Image.
   c. Place the sample into center of the drawer, ensuring the sample is positioned in the correct orientation.
   d. Select Analyse Image. There will be a short delay while the C-Cell captures and processes the image. Once completed, the Results Window will appear.
   e. Select Acquisition to return to Main Screen.
      Cell diameter and cell volume are two parameters that were measured using the C-Cell imaging system, which provide objective measurements of porosity. Cell diameter is the average diameter of cells (pixels) based on measurements of the average cell area. Cell diameter is a good general-purpose indicator of the coarseness of the texture of the baked product but does not take the depth of the cells into account. Cell volume, which is a measurement of the average volume of cells, provides an alternative measurement that also includes consideration of cell depth.

Texture was measured using the Texture Analyser model TA.XT2 (AACC International Method 74-09). The accessory test probe used was 36 mm with radius (P/26R) and a 5 kg load cell. The following settings were applied to the Texture Analyser:

| Mode | Measure Force in Compression | |
|---|---|---|
| Option | Return to Start | |
| Pre-test Speed | 1.0 | mm/s |
| Test Speed | 1.7 | mm/s |
| Post-Test Speed | 10.0 | mm/s |
| Strain | 40% | |
| Trigger Type | Auto - 5 g | |
| Tare Mode | Auto | |
| Data Acquisition Rate | 250 | pps |

Prior to testing, bread loaves were sliced horizontally at approximately half of their height. Multiple measurements were taken per bread loaf, avoiding the bigger air cells as much as possible. After testing, the Peak Force, representing the highest point in the texture curve which plots force in grams (y axis) versus time in seconds (x axis), was recorded, as reported by the equipment software.

The determination of the moisture content of the baked breads was performed using AACC Method 62-05.01 to prepare the bread sample and then AACC Method 44-15.02 to measure moisture content. Method 62-05.01 describes the preparation of the sample by drying the sample at room temperature, determining the moisture loss, and further processing the bread by reducing it to a fine 20-mesh grind. Method 44-15.02 describes the determination of moisture content as loss in weight of the prepared bread sample when heated under specified conditions in an oven (either gravity-convection or mechanical-convection), capable of being maintained at 130° (±1°) uniformly throughout oven and provided with good ventilation.

### EXAMPLES

The invention is further described in detail by reference to the following examples. These examples are provided for purposes of illustration only and are not intended to be limiting unless otherwise specified. Thus, the disclosure should in no way be construed as being limited to the following examples, but rather, should be construed to encompass any and all variations which become evident as a result of the teaching provided herein. The examples do not include detailed descriptions of conventional methods that would be well known to those of ordinary skill in the art.

In the following examples, the term “control” is used to describe a bread or dough made without an organic acid and non-wheat flour.

Effectiveness of organic acids as mix time reducers were demonstrated using Mixolab, as a proxy for bread doughs including artisan bread doughs. The results shown in Table 2 demonstrate that all organic acids had a similar effect to that of relaxers, such as L-cysteine. Specifically, fumaric acid was more effective at mimicking the action of the relaxer L-cysteine in reducing the mixing time. The use of fumaric acid also had the added effect of reducing the pH to 4.2 compared to control dough in the absence of fumaric acid. While all organic acids were effective in reducing the mixing time, various amounts of organic acids were required to achieve a similar effect. Specifically, fumaric acid was the most effective, requiring the least amount to be added to achieve a similar effect to other organic acids. This can have economic and practical advantages for bakers in an industrial setting trying to reduce mixing time using organic acids.

TABLE 2
Effect of organic acids on artisan bread dough

| | Mixing time | Water absorption | |
|---|---|---|---|
| | (minutes) | (%) | pH |
| Control | 8.28 | 67.0 | 5.9 |
| 50 ppm L-cysteine | 5.00 | 67.0 | 5.9 |
| 0.3% fwb Fumaric acid | 5.02 | 67.0 | 4.2 |
| 1.5% fwb Acetic acid | 3.77 | 67.0 | 4.2 |
| 0.7% fwb Citric acid | 5.40 | 67.0 | 4.2 |
| 1.1% fwb Lactic acid | 3.97 | 67.0 | 4.2 |
| 0.9% fwb Malic acid | 4.65 | 67.0 | 4.2 |

Effectiveness of the use of organic acids and non-wheat flour was demonstrated by preparing ciabatta and baguette breads using a preferment protocol and a straight dough protocol.

Ingredients and Preferment Protocol for Ciabatta Bread

TABLE 3
Ciabatta bread ingredients for the preferment protocol

| | | | | Final Dough |
|---|---|---|---|---|
| | | Rest of | Final | (Baker's |
| | Poolish | Ingredients | Dough | Percent or |
| | (wt. oz) | (wt. oz) | (wt. oz) | ‘% fwb’) |
| Wheat flour | 7.00 | 13.00 | 20.00 | 100.00 |
| Water | 7.00 | 8.00 | 15.00 | 75.00 |
| Yeast | 0.0007 | 0.08 | 0.08 | 0.40 |
| Salt | 0.00 | 0.40 | 0.40 | 2.00 |
| Olive oil | 0.00 | 0.20 | 0.20 | 1.00 |
| Total Poolish | 14.0007 | — | — | — |
| Total Rest of | — | 21.68 | — | — |
| Ingredients | | | | |
| Total Final Dough | — | — | 35.6807 | 178.40 |

Ciabatta bread made using the preferment protocol is baked using the ingredients provided in Table 3 and the following steps:
1. mix by hand poolish components using water at room temperature for 2 minutes;
2. hold poolish for 18 hours in closed container at room temperature;
3. to a mixing bowl, add the rest of the ingredients (except ½ of the water) and the poolish;
4. mix for 6 min at speed 1 (low) in a spiral mixer;
5. mix for 2 min at speed 2 (high) in a spiral mixer;
6. add the rest of the water and mix for another 5 minutes at speed 2;
7. if necessary, add another 5 to 10 minutes at speed 2 until water is fully incorporated;
8. ferment the dough in bulk for 3 hours, with one fold of the dough at 1 hour and another at 2 hours;
9. divide dough and scale dough pieces at 250 g;
10. proof dough pieces for 60 minutes; and
11. bake for 25 minutes at 240° C. At the start of baking, apply 10 seconds of steam.
   If being used, the organic acid and non-wheat flour are added during step 3 of the preferment protocol.

Ingredients and Preferment Protocol for Baguette Bread

TABLE 4
Baguette bread ingredients for the preferment protocol

| | | | | Final Dough |
|---|---|---|---|---|
| | | Rest of | Final | (Baker's |
| | Poolish | Ingredients | Dough | Percent or |
| | (wt. oz) | (wt. oz) | (wt. oz) | ‘% fwb’) |
| Wheat flour | 5.00 | 15.00 | 20.00 | 100.00 |
| Water | 5.00 | 9.00 | 14.00 | 70.00 |
| Yeast | 0.0005 | 0.10 | 0.1005 | 0.50 |
| Salt | 0.00 | 0.40 | 0.40 | 2.00 |
| Total Poolish | 10.0005 | — | — | — |
| Total Rest of | — | 24.50 | — | — |
| Ingredients | | | | |
| Total Final Dough | — | — | 34.5005 | 172.50 |

Baguette bread made using the preferment protocol is baked using the ingredients provided in Table 4 and the following steps:
1. mix by hand poolish components using water at room temperature for 2 minutes;
2. hold poolish for 18 hours in closed container at room temperature;
3. to a mixing bowl, add the rest of the ingredients (except ½ of the water) and the poolish;
4. mix for 6 min at speed 1 (low) in a spiral mixer;
5. mix for 2 min at speed 2 (high) in a spiral mixer;
6. ferment the dough in bulk for 2.5 hours, with one fold of the dough at 1 hour;
7. divide dough and scale dough pieces at 250 g;
8. intermediate proof for 30 minutes;
9. final proof for 60 minutes; and
10. bake for 22 minutes at 240° C. At the start of baking, apply 10 seconds of steam.
   If being used, the organic acid and non-wheat flour are added during step 3 of the preferment protocol.

Ingredients and Straight-Dough Protocol for Ciabatta Bread

TABLE 5
Ciabatta bread ingredients for the straight-dough protocol

| | | Dough Ingredients |
|---|---|---|
| | Dough Ingredients | (Baker's Percent |
| | (wt. oz) | or ‘% fwb’) |
| Wheat flour | 20.00 | 100.00 |
| Water | 15.00 | 75.00* |
| Yeast | 0.08 | 0.40 |
| Salt | 0.40 | 2.00 |
| Olive oil | 0.20 | 1.00 |
| Total Dough | 35.6807 | 178.40 |

*= absorption was increased to 78% fwb (or 15.6 wt. oz) in some cases, as indicated.

Ciabatta bread is made via a straight-dough procedure using the ingredients provided in Table 5 using the following steps:
1. add all the ingredients to a mixing bowl
2. mix for 6 or 4 min at speed 1 (low) in a spiral mixer
3. mix for 2 or 1 min at speed 2 (high)
4. ferment the dough in bulk for 3 hours, with one fold of the dough at 1 hour and another at 2 hours;
5. divide dough and scale dough pieces at 250 g;
6. proof dough pieces for 60 minutes; and
7. bake for 25 minutes at 240° C. At the start of baking, apply 10 seconds of steam.
   If being used, the organic acid and non-wheat flour are added during step 1 of the straight-dough protocol.

It will be appreciated that there may be other typical ingredients, formulas and processes to make ciabatta, baguette, or any other type of artisan bread that would be apparent to those of ordinary skill in the art.

### EXAMPLE 1: Volume, Specific Volume and pH of Ciabatta Bread Made Using the Preferment Protocol

Ciabatta bread dough was prepared using the ingredients set out in Table 3 and baked according to the ciabatta bread preferment protocol. The results shown in Table 6 demonstrate that the use of organic acids, specifically fumaric acid with non-wheat flours, specifically rice flour, is surprisingly effective in increasing the specific volume of ciabatta bread.

TABLE 6
Ciabatta volume and specific volume

| | | 0.75% fwb RF* | 0.50% fwb RF | 0% fwb RF | 0.50% fwb RF |
|---|---|---|---|---|---|
| | Control | 0.125% fwb FA** | 0.25% fwb FA | 0.25% fwb FA | 0% fwb FA |
| Volume (cc) | 877 | 772 | 857 | 919 | 820 |
| | 763 | 795 | 886 | 891 | 788 |
| | 729 | 822 | 889 | 883 | 856 |
| | 721 | 808 | 824 | 867 | 846 |
| AVG | 772.5 | 799.25 | 864 | 890 | 827.5 |
| SD | 72.0 | 21.3 | 30.3 | 21.8 | 30.4 |
| Sp. Vol. (cc/g) | 4.52 | 4.19 | 4.62 | 4.75 | 4.41 |
| | 4.08 | 4.31 | 4.72 | 4.53 | 4.31 |
| | 4.21 | 4.29 | 4.85 | 4.79 | 4.49 |
| | 4.23 | 4.38 | 4.66 | 4.54 | 4.67 |
| AVG | 4.26 | 4.29 | 4.71 | 4.65 | 4.47 |
| SD | 0.19 | 0.08 | 0.10 | 0.13 | 0.15 |

*RF is Rice Flour
**FA is Fumaric Acid

TABLE 7
Ciabatta bread Ph

| Sample | Ciabatta pH |
|---|---|
| Control | 5.83 |
| 0.125% fwb FA + 0.75% fwb RF | 5.29 |
| 0.25% fwb FA + 0.5% fwb RF | 4.80 |
| 0.25% fwb FA | 4.83 |
| 0.5% fwb RF | 5.81 |

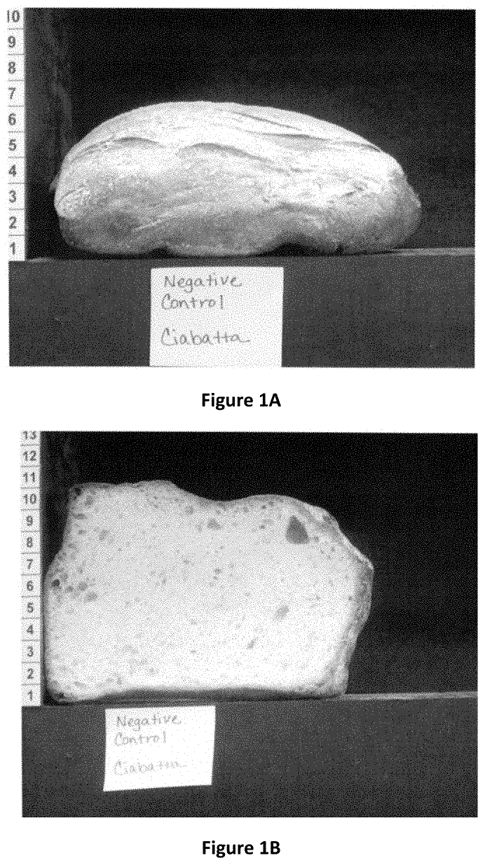

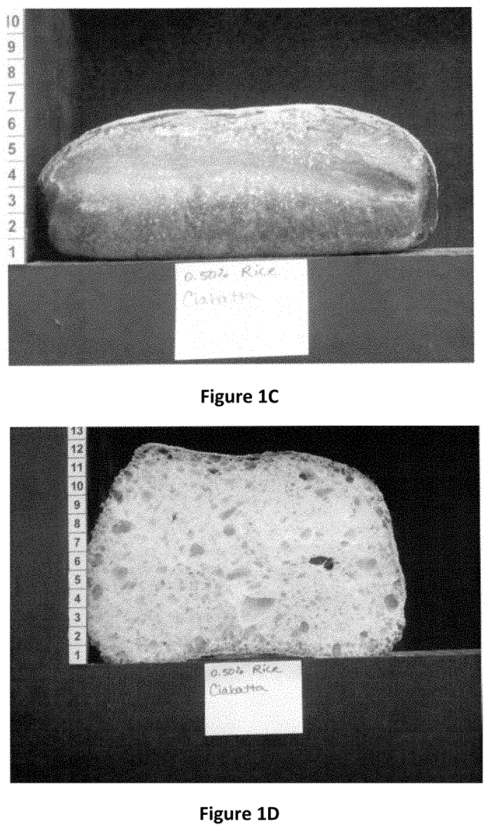

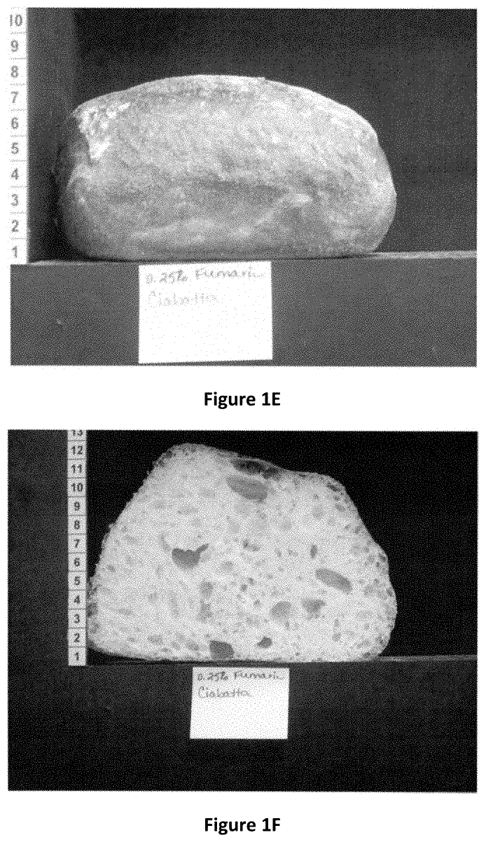

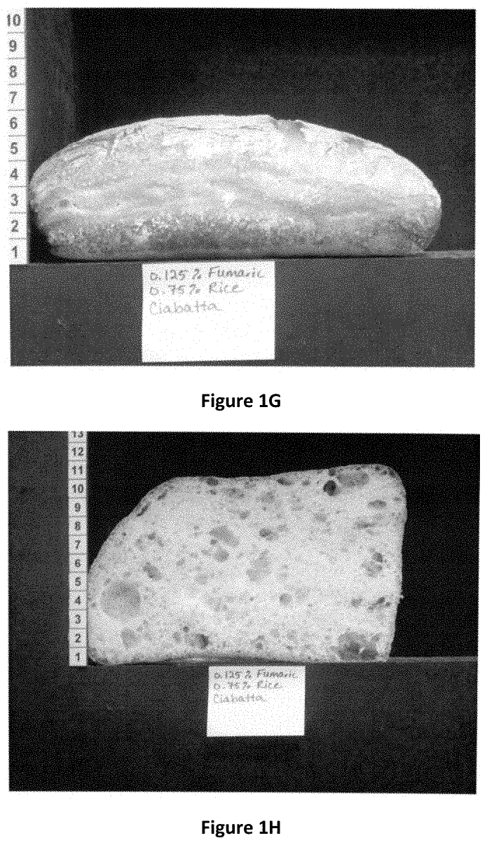

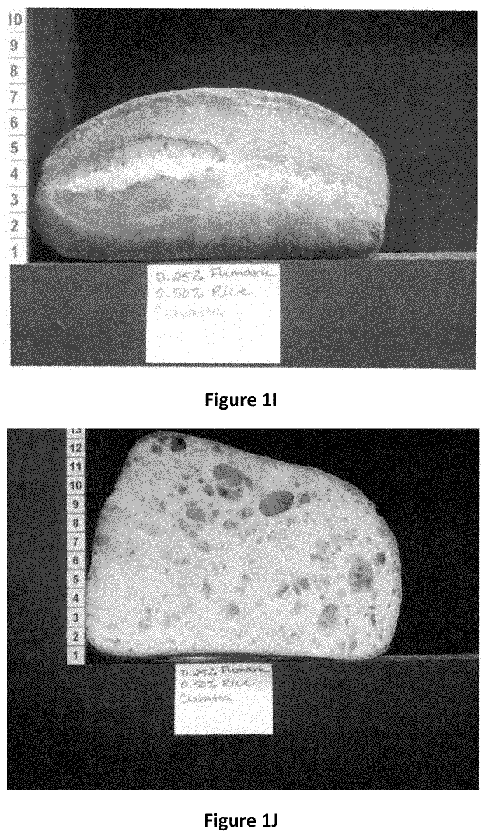

FIGS. 1A-J illustrates the exterior and horizontal slice images of ciabatta bread baked in the absence, and presence of varying % fwb of fumaric acid and rice flour. FIG. 1G and 1H illustrate the preferred embodiment, baked using 0.125% fwb fumaric acid and 0.75% fwb rice flour, which results in a marked increase in the volume (Table 6) and porosity of the bread while maintaining a more uniform and aesthetically-pleasing shape. Use of 0.125% fwb fumaric acid and 0.75% fwb rice flour also resulted in only a moderate decrease of pH compared to the control as illustrated in Table 7. FIGS. 1I and 1J illustrate another preferred embodiment, baked using 0.25% fwb fumaric acid and 0.50% fwb rice flour, which results in a marked increase in the volume (Table 6) and porosity of the bread while maintaining a more uniform and aesthetically-pleasing shape. Use of 0.25% fwb fumaric acid and 0.50% fwb rice flour also resulted in a more pronounced decrease of pH compared to the control as illustrated in Table 7.

### EXAMPLE 2: Volume, Specific Volume and pH of Baguette Bread Made Using the Preferment Protocol

Baguette bread dough was prepared using the ingredients set out in Table 4 and baked according to the baguette bread preferment protocol. The results shown in Table 8 demonstrate that the use of organic acids, specifically fumaric acid with non-wheat flours, specifically rice flour is surprisingly effective in increasing the specific volume of baguette bread.

TABLE 8
Baguette bread volume and specific volume

| | | 0.75% fwb RF* | 0.50% fwb RF | 0% fwb RF | 0.50% fwb RF |
|---|---|---|---|---|---|
| | Control | 0.125% fwb FA** | 0.25% fwb FA | 0.25% fwb FA | 0% fwb FA |
| Volume (cc) | 761 | 768 | 781 | 923 | 724 |
| | 728 | 799 | 764 | 890 | 726 |
| | 740 | 766 | 753 | 753 | 706 |
| | 705 | 736 | 705 | 814 | 750 |
| AVG | 733.5 | 767.25 | 750.75 | 845 | 726.5 |
| SD | 23.4 | 25.7 | 32.6 | 76.5 | 18.1 |
| Sp. Vol. (cc/g) | 4.29 | 4.40 | 4.35 | 5.12 | 4.06 |
| | 4.12 | 4.34 | 4.43 | 5.15 | 4.16 |
| | 4.04 | 4.33 | 4.34 | 4.52 | 4.08 |
| | 3.99 | 4.29 | 4.01 | 4.72 | 4.14 |
| AVG | 4.11 | 4.34 | 4.28 | 4.88 | 4.11 |
| SD | 0.13 | 0.05 | 0.19 | 0.31 | 0.05 |

*RF is Rice Flour
**FA is Fumaric Acid

TABLE 9
Baguette bread pH

| Sample | Baguette pH |
|---|---|
| Control | 5.74 |
| 0.125% fwb FA + 0.75% fwb RF | 5.20 |
| 0.25% fwb FA + 0.5% fwb RF | 4.79 |
| 0.25% fwb FA | 4.81 |
| 0.5% fwb RF | 5.74 |

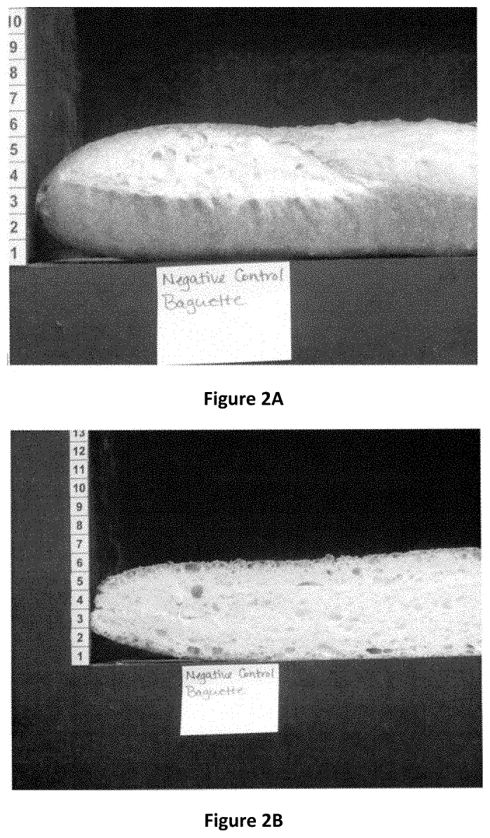

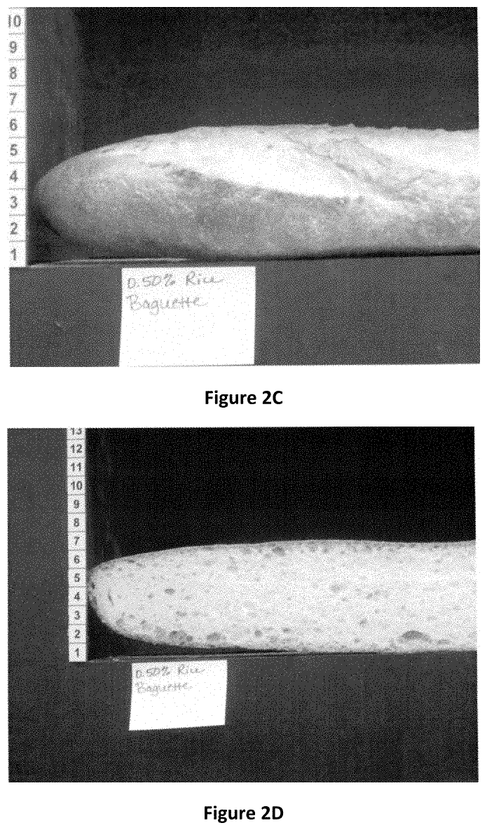

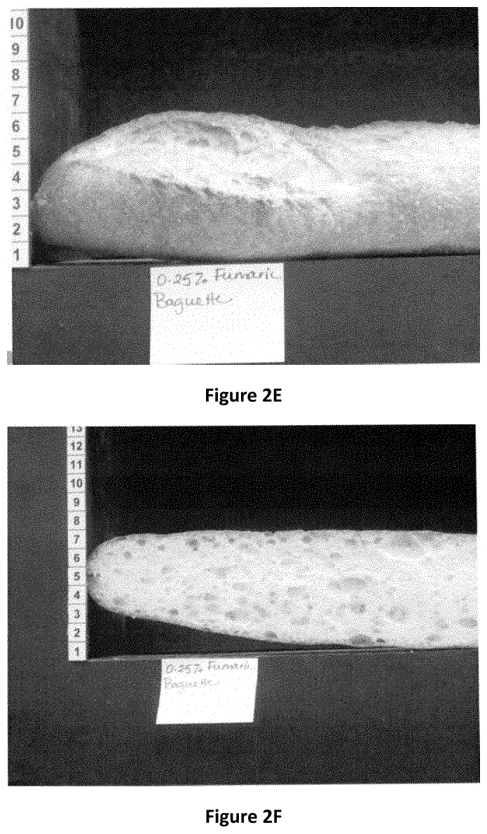

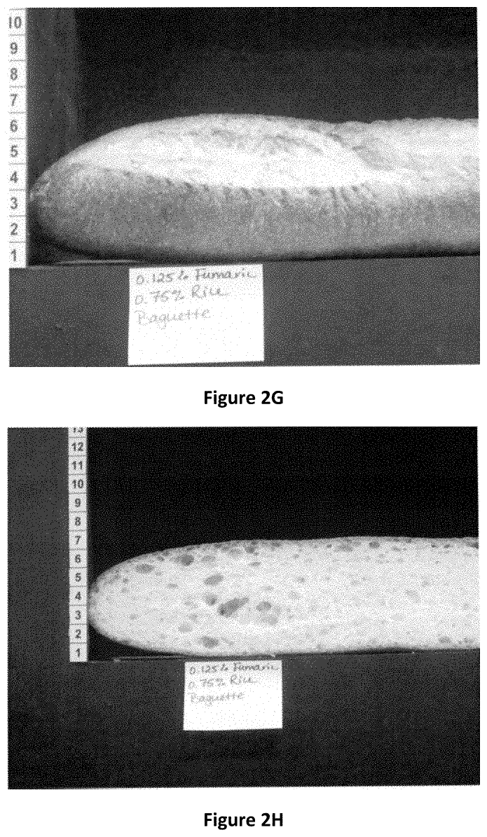

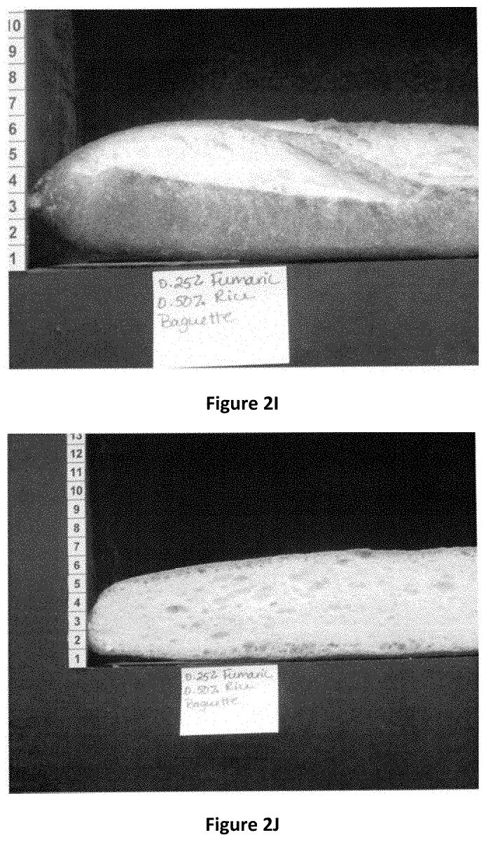

FIGS. 2A-J illustrates the exterior and horizontal slices of baguette bread baked in the absence, and presence of varying % fwb of fumaric acid and rice flour. FIG. 2G and 2H illustrate the preferred embodiment, baked using 0.125% fwb fumaric acid and 0.75% fwb rice flour, which results in a marked increase in the volume (Table 8) and porosity of the bread while maintaining a more uniform and aesthetically-pleasing shape. Use of 0.125% fwb fumaric acid and 0.75% fwb rice flour also resulted in only a moderate decrease of pH compared to the control as illustrated in Table 9. FIGS. 2I and 2J illustrate another preferred embodiment, baked using 0.25% fwb fumaric acid and 0.50% fwb rice flour, which results in a marked increase in the volume (Table 8) and porosity of the bread while maintaining a more uniform and aesthetically-pleasing shape. Use of 0.25% fwb fumaric acid and 0.50% fwb rice flour also resulted in a more pronounced decrease of pH compared to the control as illustrated in Table 9.

### EXAMPLE 3: Dough Rheology Scores for Artisan Breads Made Using the Preferment Protocol

Ciabatta and baguette bread doughs were prepared using the ingredients set out in Table 3 and Table 4, respectively, and according to the ciabatta bread preferment protocol and the baguette bread preferment protocol, as described above. The ciabatta bread dough was prepared using three wheat flours with different protein content (10%, 12% and 13%). The baguette bread dough was prepared using wheat flour with 13% protein content. The doughs were mixed, evaluated, and assigned an informal dough rheology score. The results shown in Table 10 demonstrate that, a stronger dough rheology can be obtained in artisan bread doughs made with different qualities of wheat flours, by adding organic acids, specifically fumaric acid with non-wheat flours, specifically rice flour.

TABLE 10
Informal dough rheology score of artisan breads
baked using the preferment protocol

| Flour protein | | |
|---|---|---|
| 10% | 12% | 13% |

Bread system

| | Ciabatta | | | Baguette |
|---|---|---|---|---|
| Control | 1 | 2 | 3 | 4 |
| 0.125% fwb FA + | | 4 | 5 | |
| 0.75% fwb RF | | | | |
| 0.25% fwb FA + | 3 | | 6 | 6 |
| 0.50% fwb RF | | | | |

### EXAMPLE 4: Dough Rheology Scores for Ciabatta Bread Made Using the Straight-Dough Protocol

Ciabatta bread dough was prepared using the ingredients set out in Table 5 according to the ciabatta bread straight-dough protocol. The ciabatta bread dough was prepared using wheat flour with 13% protein content. The dough mix time was 8 minutes (unless otherwise noted in Table 11) and tests were completed for a dough absorption of 75% and 78%. The baked bread was assessed and assigned an informal dough rheology score. The dough was mixed, evaluated, and assigned an informal dough rheology score. The results shown in Table 11 demonstrate that, a stronger dough rheology can be obtained in artisan bread doughs made with wheat flours of different protein contents, by adding organic acids, specifically fumaric acid, with non-wheat flours, specifically rice flour.

TABLE 11
Informal dough rheology score for ciabatta bread
made using the straight-dough protocol

Dough absorption

| | 75% | 78% |
|---|---|---|
| Control | 5 | 2 |
| 0.125% fwb FA + 0.75% fwb RF | 6 | 4 |
| 0.25% fwb FA + 0.50% fwb RF | 7 | 6, 4* |

*= Dough mix time was adjusted to 5 minutes.

### EXAMPLE 5: Porosity of Ciabatta Bread Made Using the Straight-Dough Protocol and Wheat Flour with 12% Protein Content

Ciabatta bread dough was prepared using the ingredients set out in Table 5 and baked according to the ciabatta bread straight-dough protocol. The ciabatta bread dough was prepared using wheat flour with 12% protein content, dough absorption of 78% and a mix time of 8 minutes. The results shown in Table 12 demonstrate that the use of organic acids, specifically fumaric acid with non-wheat flours, specifically rice flour is surprisingly effective in increasing the porosity of ciabatta bread.

TABLE 12
Porosity and pH of ciabatta bread made using the straight-
dough protocol and wheat flour with 12% protein content

| | Porosity Measures [Mean (S.D.)] | | |
|---|---|---|---|
| Sample | Cell Diameter | Cell Volume | pH |
| Control | 5.18 (0.12) | 19.49 (0.74) | 5.87 |
| 0.25% fwb FA + | 6.62 (0.39) | 24.13 (1.07) | 4.70 |
| 0.50% fwb RF | | | |

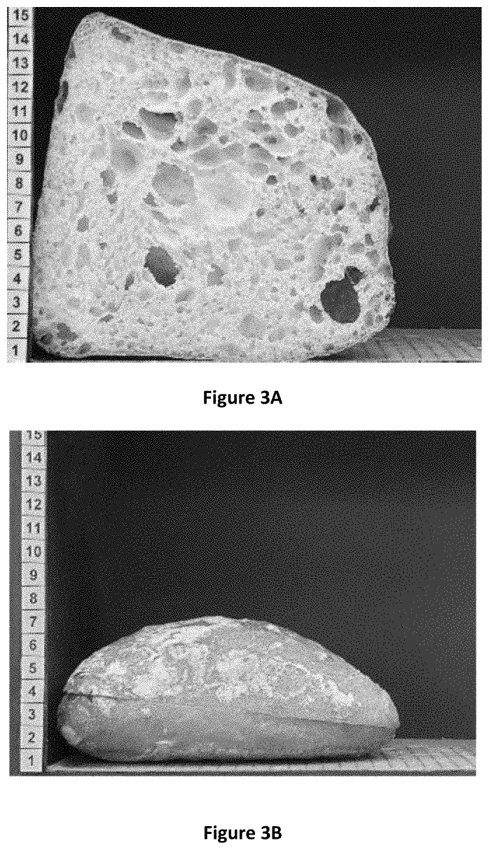

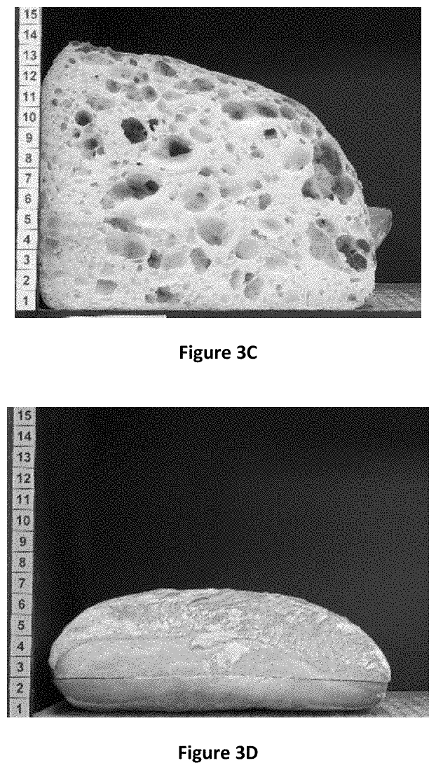

FIGS. 3A-D illustrate the exterior and horizontal slice images of ciabatta bread baked in the absence, and presence of fumaric acid and rice flour. FIGS. 3C and 3D illustrate a preferred embodiment, baked using 0.25% fwb fumaric acid and 0.50% fwb rice flour, which results in a marked increase in the cell diameter and cell volume of the bread as compared to the control (Table 12). FIGS. 3C and 3D show the visual improvement in the porosity of the crumbs, as well as a more even and aesthetically-pleasing dome shape of the bread loaf as compared to the control.

### EXAMPLE 6: Dough Rheology and Porosity of Ciabatta Bread Made Using the Straight-Dough Protocol and 13% Protein Flour

Ciabatta bread dough was prepared using the ingredients set out in Table 5 and baked according to the ciabatta bread straight-dough protocol. The ciabatta bread dough was prepared using wheat flour with 13% protein content. The results shown in Table 13 demonstrate that dough absorption and mix times can be altered to optimize the benefits in the dough and in the finished products in artisan breads prepared with the use of organic acids, specifically fumaric acid with non-wheat flours, specifically rice flour.

TABLE 13
Ciabatta bread made using the straight-dough protocol and 13% protein flour

| | | | Informal | Porosity Measures | | | Bread | |
|---|---|---|---|---|---|---|---|---|
| | | Dough | dough | [Mean (S.D.)] | | | moisture | Informal |
| Dough | | mix time | rheology | Cell | Cell | | [%, Mean | Sensory |
| absorption | Sample | (min) | score | Diameter | Volume | pH | (S.D.)] | Sourness |
| 75% | Control | 8 | 5 | 4.59 | 17.06 | 5.89 | 35.0 | Plain flavor and |
| | | | | (0.55) | (1.78) | | (0.8) | aroma, not sour |
| 78% | Control | | 2 | NA* | NA* | 5.85 | NA | NA |
| | 0.125% fwb | | 4 | 5.04 | 17.96 | 5.17 | 35.8 | Slightly sour |
| | FA + 0.75% | | | (1.06) | (4.46) | | (0.2) | flavor and aroma |
| | fwb RF | | | | | | | |
| | 0.25% fwb | | 6 | 5.37 | 19.62 | 4.75 | 35.0 | Moderately sour |
| | FA + 0.50% | | | (1.14) | (4.82) | | (1.1) | flavor and aroma |
| | fwb RF | 5 | 4 | 7.60 | 30.76 | N | NA | NA |
| | | | | (1.18) | (6.04) | | | |

*= dough collapses during baking, due to weak dough rheology

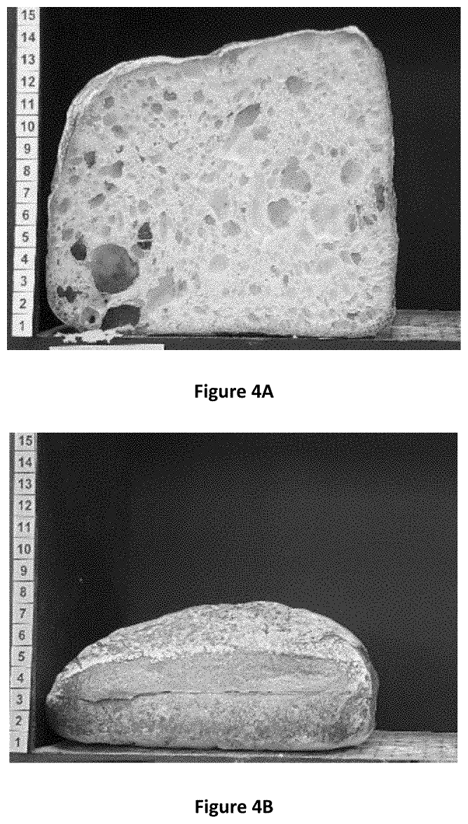

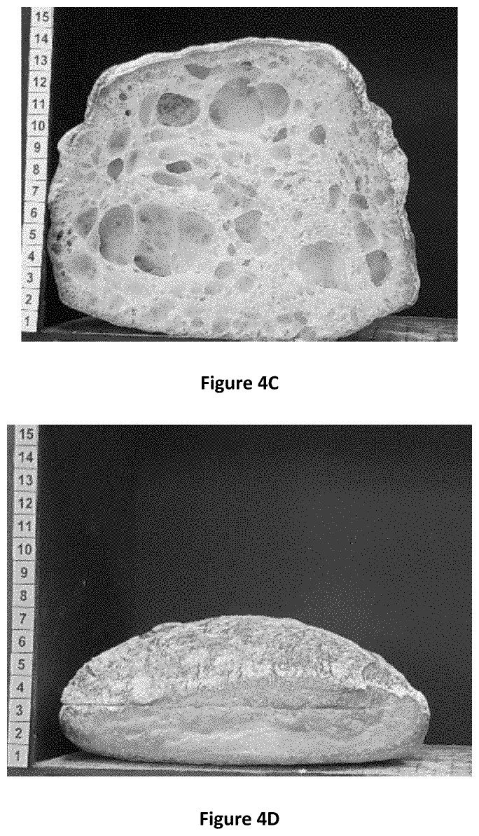

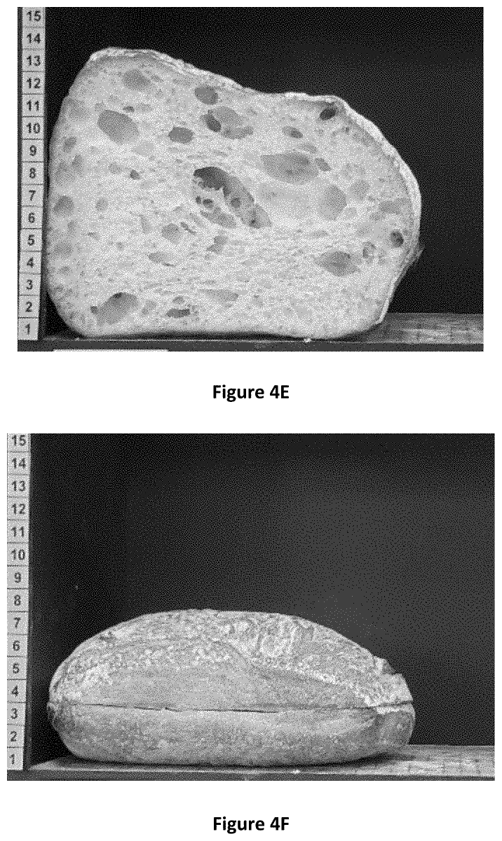

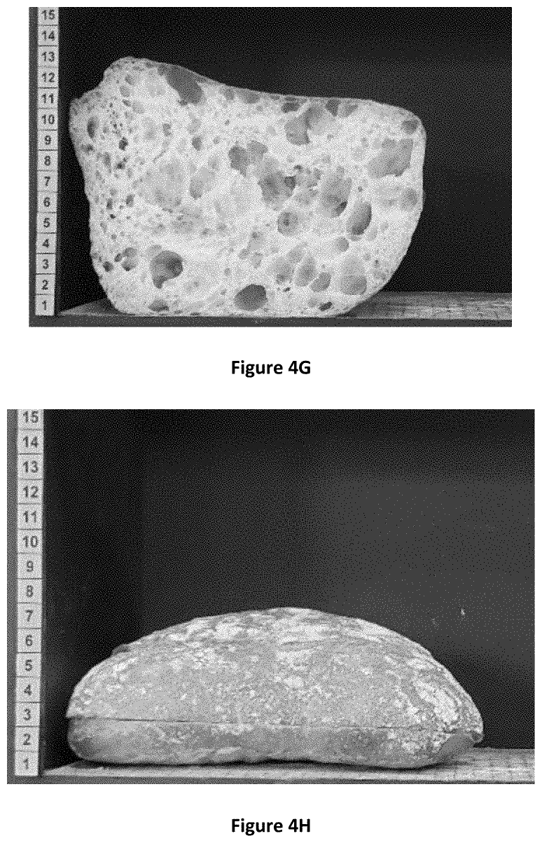

FIGS. 4A-H illustrate the exterior and horizontal slices of ciabatta bread baked using the straight-dough protocol in the absence, and presence of varying % fwb of fumaric acid and rice flour. FIGS. 4C and 4D illustrate a preferred embodiment, baked using 0.125% fwb fumaric acid and 0.75% fwb rice flour with 78% dough absorption and a mix time of 8 minutes, which results in a balanced dough rheology (score 4) and improved porosity of the bread (Table 13) while maintaining a more uniform and aesthetically-pleasing shape. Use of 0.125% fwb fumaric acid and 0.75% fwb rice flour also resulted in only a moderate decrease of pH compared to the control as illustrated in Table 13. FIGS. 4E to 4H illustrate another preferred embodiment, baked using 0.25% fwb fumaric acid and 0.50% fwb rice flour, which results in a marked improvement in the porosity of the bread (Table 13) while maintaining a more uniform and aesthetically-pleasing shape, as compared to the control. FIG. 4G and 4H illustrate that a balanced dough rheology (score 4) and an improvement in porosity can be achieved while maintaining a more uniform and aesthetically-pleasing loaf shape when the dough mix time was reduced from 8 minutes to 5 minutes.

### EXAMPLE 7: Porosity, Dough Rheology, and Texture of Ciabatta Bread Made Using the Preferment Protocol and Wheat Flour with 13% Protein Content

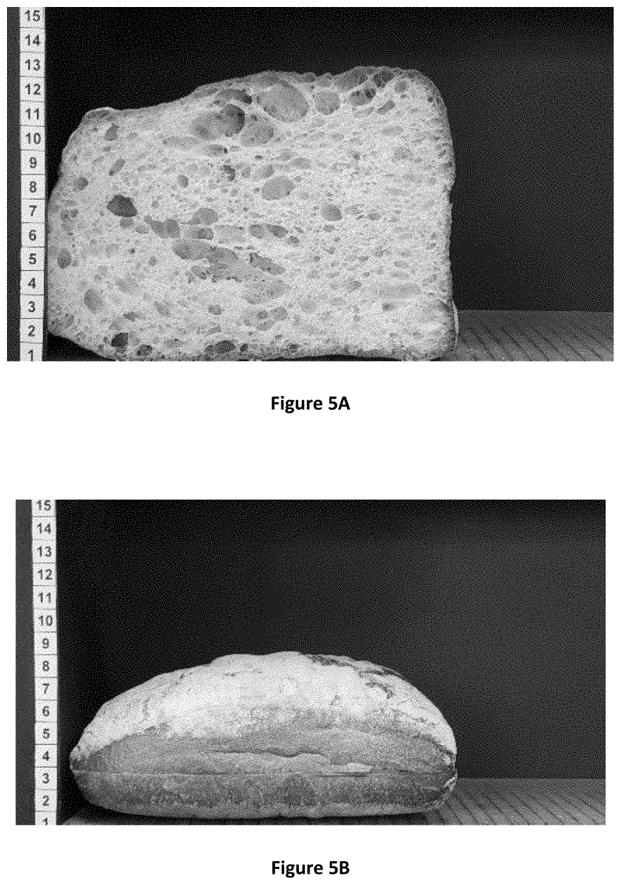

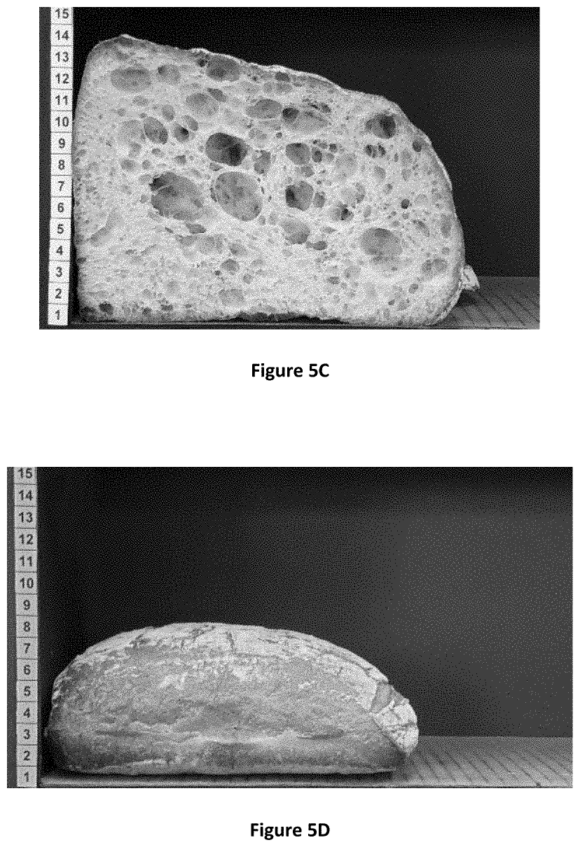

Ciabatta bread dough was prepared using the ingredients set out in Table 3 and baked according to the ciabatta bread preferment protocol. The ciabatta bread dough was prepared using wheat flour with 13% protein content and a dough absorption of 75%. The results of this study, shown in Table 14 and FIGS. 5A-5E, demonstrate that the use of organic acids, specifically fumaric acid with non-wheat flours, specifically rice flour is surprisingly effective in increasing the porosity and improving the shelf-life of the ciabatta bread.

TABLE 14
Ciabatta bread made using the preferment protocol

| | | Porosity Measures | | Informal | | Bread | |
|---|---|---|---|---|---|---|---|
| | Dough | [Mean (S.D.)] | | dough | | moisture | Informal |
| | mix time | Cell | Cell | rheology | | [%, Mean | Sensory |
| Sample | (min) | Diameter | Volume | score | pH | (S.D.)] | Sourness |
| Control | 12.7 | 4.17 | 15.27 | 3 | 5.88 | 32.05 | Plain flavor and |
| | | (0.62) | (2.87) | | | (2.14) | aroma, not sour |
| 0.25% fwb | 10.3 | 4.84 | 18.27 | 6 | 4.72 | 33.28 | Moderately sour |
| FA + 0.50% | | (0.15) | (0.89) | | | (0.711) | flavor and aroma |
| fwb RF | | | | | | | |

FIGS. 5A-D illustrate the exterior and horizontal slice images of ciabatta bread baked in the absence, and presence of fumaric acid and rice flour. FIGS. 5C and 5D illustrate a preferred embodiment, baked using 0.25% fwb fumaric acid and 0.50% fwb rice flour, which results in a marked increase in the cell diameter and cell volume of the bread as compared to the control (Table 14). FIGS. 5C and 5D show the visual improvement in the porosity of the crumbs, as well as a more even and aesthetically-pleasing dome shape of the bread loaf as compared to the control.

The texture of the ciabatta bread was assessed by measuring the Peak Force of the bread using the Texture Analyzer once a day for 4 days. FIG. 5E illustrates that the ciabatta bread baked using 0.25% fwb fumaric acid and 0.50% fwb rice flour was consistently softer than the control throughout the length of the study, as it had consistently lower mean Peak Force values. The end of shelf life due to staling/firming was determined to be at about the 3-day point (via informal sensory testing) for the ciabatta bread baked in the absence of fumaric acid and rice flour, which corresponds to a Peak Force above 1200 grams. As indicated by the two-headed arrow in FIG. 5E, the ciabatta bread baked using 0.25% fwb fumaric acid and 0.50% fwb rice flour reached a similar Peak Force level after 4 days, indicating an extension of shelf life of approximately 1 day as compared to the control.

### EXAMPLE 8: Porosity, Dough Rheology and Bread Volume of Baguette Bread Made Using the Preferment Protocol

Baguette bread dough was prepared using the ingredients set out in Table 4 and baked according to the baguette bread preferment protocol. The baguette bread dough was prepared using wheat flour with 13% protein content and at 70% dough absorption. The dough mix times were fixed at 8 minutes. The results of this study demonstrate that the use of organic acids, specifically fumaric acid with non-wheat flours, specifically rice flour is surprisingly effective in improving the porosity and bread volume of the baguette bread.

TABLE 15
Baguette bread made using the preferment protocol and 13% protein flour

| | Porosity Measures | | Bread | Informal | | Bread | |
|---|---|---|---|---|---|---|---|
| | [Mean (S.D.)] | | volume, cc | dough | | moisture | Informal |
| | Cell | Cell | [Mean | rheology | | [%, Mean | Sensory |
| Sample | Diameter | Volume | (S.D.)] | score | pH | (S.D.)] | Sourness |
| Control | 3.76 | 13.45 | 946.6 | 4 | 5.89 | 29.0 | Plain flavor and |
| | (0.27) | (1.84) | (62.2) | | | (2.3) | aroma, not sour |
| 0.25% fwb | 4.12 | 14.53 | 962.3 | 6 | 4.72 | 31.1 | Moderately sour |
| FA + 0.50% | (1.30) | (5.30) | (50.6) | | | (3.1) | flavor and aroma |
| fwb RF | | | | | | | |

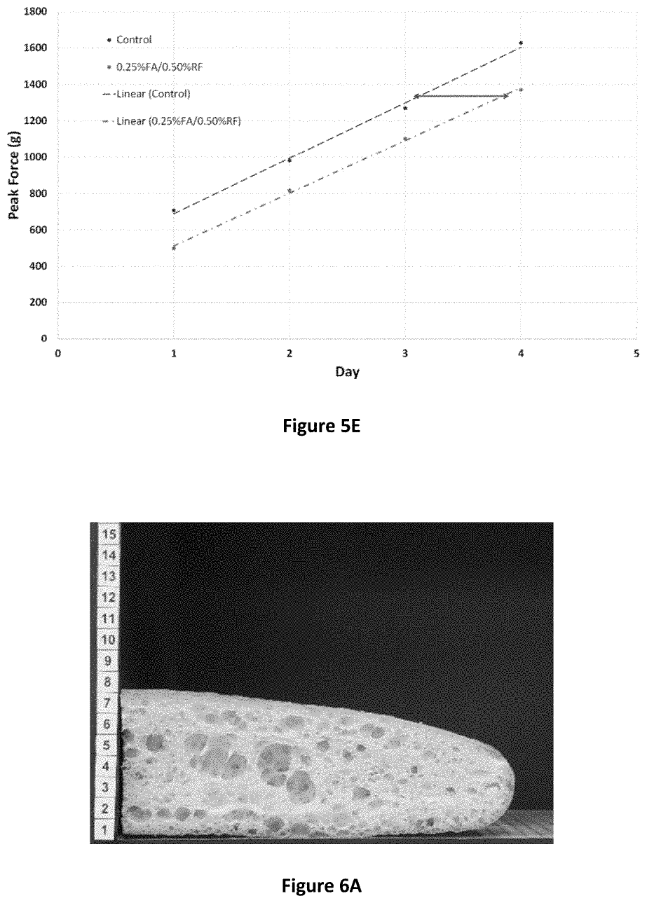

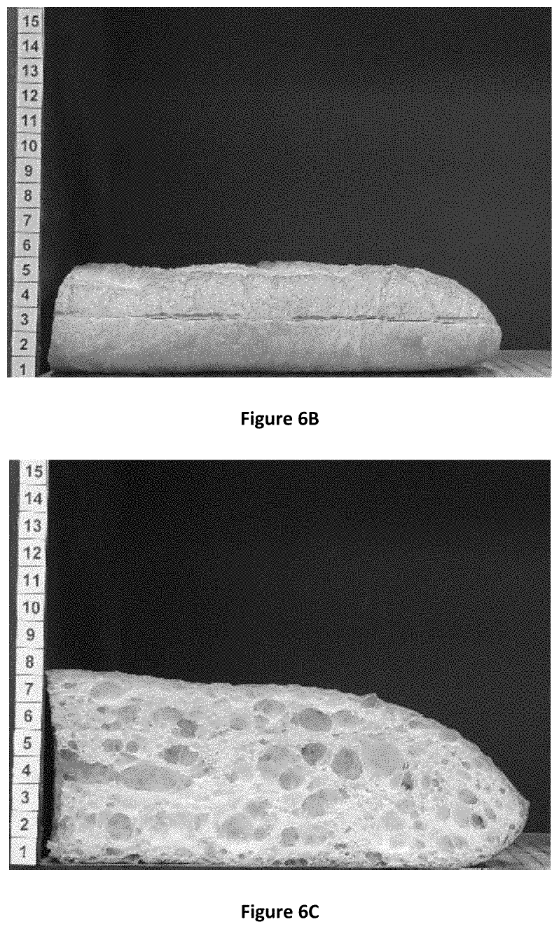

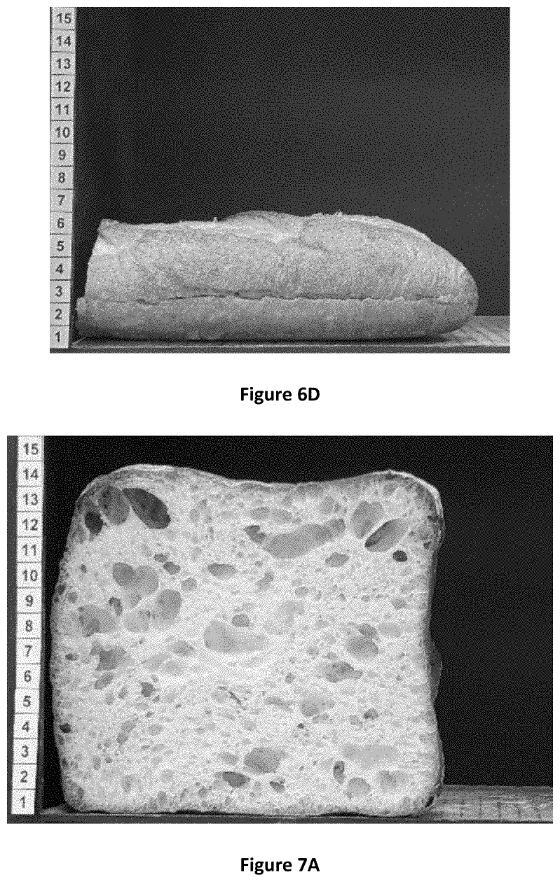

FIGS. 6A-D illustrate the exterior and horizontal slice images of baguette bread baked in the absence, and presence of fumaric acid and rice flour. FIGS. 6C and 6D illustrate a preferred embodiment, baked using 0.25% fwb fumaric acid and 0.50% fwb rice flour, which results in a marked increase in the cell diameter and cell volume of the bread, as well as the bread volume, as compared to the control (Table 15). FIGS. 6C and 6D show the visual improvement in the porosity of the crumbs, as well as a more even and aesthetically-pleasing dome shape of the bread loaf as compared to the control.

EXAMPLE 9: Dough Rheology, Porosity and Texture of Ciabatta Bread Made Using the Preferment Protocol and Wheat Flour with 12% Protein Content

Ciabatta bread dough was prepared using the ingredients set out in Table 3 and baked according to the ciabatta bread preferment protocol. The ciabatta bread dough was prepared using wheat flour with 12% protein content and at 75% dough absorption. The results of this study demonstrate that the use of organic acids, specifically fumaric acid with non-wheat flours, specifically rice flour is surprisingly effective in improving the porosity, bread moisture and the shelf-life of the ciabatta bread while maintaining a balanced dough rheology.

TABLE 16
Ciabatta bread made using the preferment protocol and 12% protein flour

| | | Informal | Porosity Measures | | | Bread | |
|---|---|---|---|---|---|---|---|
| | Dough | dough | [Mean (S.D.)] | | | moisture | Informal |
| | mix time | rheology | Cell | Cell | | [%, Mean | Sensory |
| Sample | (min) | score | Diameter | Volume | pH | (S.D.)] | Sourness |
| Control | 10.8 | 2 | 4.41 | 16.41 | 5.84 | 31.7 | Plain flavor and |
| | | | (0.29) | (1.20) | | (0.2) | aroma, not sour |
| 0.125% fwb | 10.0 | 4 | 4.76 | 17.26 | 5.17 | 33.0 | Plain flavor, |
| FA + 0.725% | | | (0.39) | (1.99) | | (1.8) | slightly sour aroma |
| fwb RF | | | | | | | |

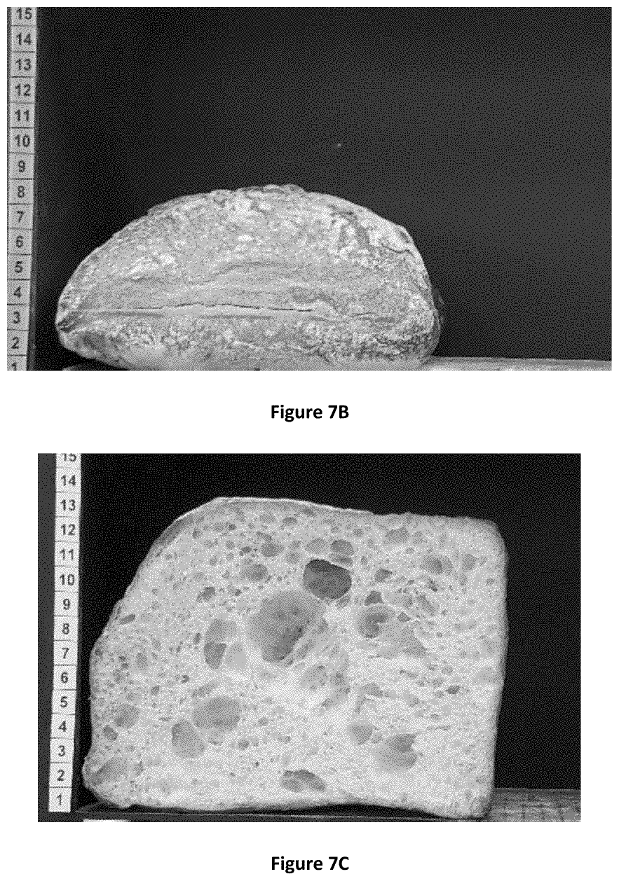

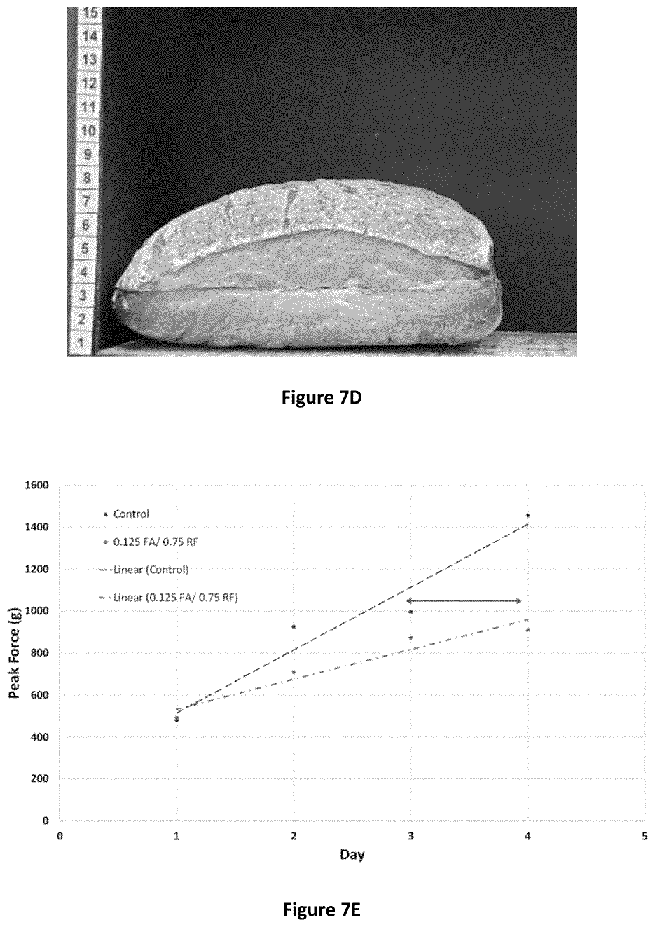

FIGS. 7A-D illustrate the exterior and horizontal slice images of ciabatta bread baked using the preferment protocol in the absence, and presence of fumaric acid and rice flour. FIGS. 7C and 7D illustrate a preferred embodiment, baked using 0.125% fwb fumaric acid and 0.725% fwb rice flour, which results in a marked increase in the cell diameter and cell volume of the bread as compared to the control (Table 16). FIGS. 5C and 5D show the visual improvement in the porosity of the crumbs, as well as a more even and aesthetically-pleasing dome shape of the bread loaf as compared to the control.

The texture of the ciabatta bread was assessed by measuring the Peak Force of the bread using the Texture Analyzer once a day for 4 days. FIG. 7E illustrates that the ciabatta bread baked using 0.125% fwb fumaric acid and 0.725% fwb rice flour was consistently softer than the control throughout the length of the study, as it had consistently lower mean Peak Force values. The end of shelf life due to staling/firming was determined to be at about the 3-day point (via informal sensory testing) for the ciabatta bread baked in the absence of fumaric acid and rice flour, which corresponds to a Peak Force above 1000 grams. As indicated by the two-headed arrow in FIG. 7E, the ciabatta bread baked using 0.125% fwb fumaric acid and 0.725% fwb rice flour had not reached a 1000 gram Peak Force after 4 days, indicating an extension of shelf life of approximately 1 day as compared to the control.

### EXAMPLE 12: Baguette Bread Baked Using a Straight-Dough Protocol

Baguette bread may be prepared according to a straight-dough protocol. To do so, the baguette bread may be prepared using the ingredients or similar ingredients set out in Table 4 and baked without a preferment step, but instead adding and mixing all the ingredients during the dough preparation. 0.05% fwb to 3% fwb fumaric acid, acetic acid, citric acid, lactic acid, or malic acid may be used with 0.1% fwb to 5% fwb rice flour, corn flour, tapioca flour, potato flour, buckwheat flour, amaranth flour, chickpea flour, oat flour, almond flour, rye flour, spelt flour, coconut flour, teff flour, millet flour, faba bean flour, pea flour, sorghum flour, quinoa flour, barley flour, almond flour, peanut flour, arrowroot flour, banana flour, sunflower seed flour, soy flour, canola flour, rapeseed flour, or flaxseed flour, which may be surprisingly effective in improving dough rheology (consistency), increasing bread volume, bread porosity, textural shelf life, aroma and flavor, while maintaining a more uniform and aesthetically-pleasing shape.

### EXAMPLE 11: Ciabatta Bread with Other Organic Acids and Non-Wheat Flour

Ciabatta bread may be prepared using the ingredients or similar ingredients set out in Table 3 and baked according to the ciabatta bread preferment protocol or using the ingredients or similar ingredients set out in Table 5 and baked according to the ciabatta bread straight-dough protocol. 0.05% fwb to 3% fwb fumaric acid, acetic acid, citric acid, lactic acid, or malic acid may be used with 0.1% fwb to 5% fwb rice flour, corn flour, tapioca flour, potato flour, buckwheat flour, amaranth flour, chickpea flour, oat flour, almond flour, rye flour, spelt flour, coconut flour, teff flour, millet flour, faba bean flour, pea flour, sorghum flour, quinoa flour, barley flour, almond flour, peanut flour, arrowroot flour, banana flour, sunflower seed flour, soy flour, canola flour, rapeseed flour, or flaxseed flour, which may be surprisingly effective in improving dough rheology (consistency), increasing bread volume, bread porosity, textural shelf life, aroma and flavor, while maintaining a more uniform and aesthetically-pleasing shape.

### EXAMPLE 12: Baguette Bread with Other Organic Acids and Non-Wheat Flour

Baguette bread may be prepared using the ingredients or similar ingredients set out in Table 4 and baked according to the baguette bread preferment protocol. Baguette bread may also be baked according to a straight-dough protocol. 0.05% fwb to 3% fwb fumaric acid, acetic acid, citric acid, lactic acid, or malic acid may be used with 0.1% fwb to 5% fwb rice flour, corn flour, tapioca flour, potato flour, buckwheat flour, amaranth flour, chickpea flour, oat flour, almond flour, rye flour, spelt flour, coconut flour, teff flour, millet flour, faba bean flour, pea flour, sorghum flour, quinoa flour, barley flour, almond flour, peanut flour, arrowroot flour, banana flour, sunflower seed flour, soy flour, canola flour, rapeseed flour, or flaxseed flour, which may be surprisingly effective in improving dough rheology (consistency), increasing bread volume, bread porosity, textural shelf life, aroma and flavor, while maintaining a more uniform and aesthetically-pleasing shape.

### EXAMPLE 13: Artisan Bread

Any type of artisan bread may be prepared using the ingredients or similar ingredients set out in Tables 3 to 5 and baked in a similar fashion to the ciabatta and baguette bread baking protocols. 0.05% fwb to 3% fwb fumaric acid, acetic acid, citric acid, lactic acid, or malic acid may be used with 0.1% fwb to 5% fwb rice flour, corn flour, tapioca flour, potato flour, buckwheat flour, amaranth flour, chickpea flour, oat flour, almond flour, rye flour, spelt flour, coconut flour, teff flour, millet flour, faba bean flour, pea flour, sorghum flour, quinoa flour, barley flour, almond flour, peanut flour, arrowroot flour, banana flour, sunflower seed flour, soy flour, canola flour, rapeseed flour, or flaxseed flour, which may be surprisingly effective in improving dough rheology (consistency), increasing bread volume, bread porosity, textural shelf life, aroma and flavor, while maintaining a more uniform and aesthetically-pleasing shape.

Although the disclosure has been described with reference to certain specific embodiments, various modifications thereof will be apparent to those of ordinary skill in the art. Any examples provided herein are included solely for the purpose of illustrating the disclosure and are not intended to limit the disclosure in any way. Any drawings provided herein are solely for the purpose of illustrating various aspects of the disclosure and are not intended to be drawn to scale or to limit the disclosure in any way. The scope of the claims appended hereto should not be limited by the preferred embodiments set forth in the above description, but should be given the broadest interpretation consistent with the present specification as a whole. The disclosures of all documents cited herein are incorporated herein by reference in their entirety.

What is claimed is:

1. A dough additive comprising an organic acid and a non-wheat flour.

2. The dough additive of claim 1, wherein the amount of the organic acid is 0.05% fwb to 5% fwb and the amount of the non-wheat flour is 0.1% fwb to 5% fwb.

3. The dough additive of claim 1, wherein the organic acid is fumaric acid, acetic acid, citric acid, lactic acid, malic acid, phosphoric acid, sorbic acid, ascorbic acid, adipic acid, gluconic acid, glucono delta-lactone or tartaric acid.

4. The dough additive of claim 1, wherein the non-wheat flour is rice flour, corn flour, tapioca flour, potato flour, buckwheat flour, amaranth flour, chickpea flour, oat flour, almond flour, rye flour, spelt flour, coconut flour, teff flour, millet flour, faba bean flour, pea flour, sorghum flour, quinoa flour, barley flour, peanut flour, arrowroot flour, banana flour, sunflower seed flour, soy flour, canola flour, rapeseed flour or flaxseed flour.

5. The dough additive of claim 1, wherein the organic acid is fumaric acid and the non-wheat flour is rice flour.

6. The dough additive of claim 5, wherein the amount of fumaric acid is 0.125% fwb and the amount of rice flour is 0.75% fwb.

7. The dough additive of claim 5, wherein the amount of fumaric acid is 0.25% fwb and the amount of rice flour is 0.50% fwb.

8. Use of a dough additive in an artisan bread, wherein the dough additive comprises an organic acid and a non-wheat flour.

9. The use according to claim 8, wherein the artisan bread is a ciabatta bread, a baguette bread, a bolillo bread, a batard bread, a boule bread, a bagel, a stollen bread, a fougasse bread, a focaccia bread, a sourdough bread, a rye bread, a pumpernickel bread, a white bread, a multigrain bread, a panettone bread, a challah bread or a brioche bread.

10. The use according to claim 8, wherein the artisan bread is baked using a preferment process.

11. The use according to claim 8, wherein the artisan bread is baked using a straight-dough process.

12. The use according to claim 8, wherein the amount of the organic acid is 0.05% fwb to 5% fwb and the amount of the non-wheat flour is 0.1% fwb to 5% fwb.

13. The use according to claim 8, wherein the organic acid is fumaric acid, acetic acid, citric acid, lactic acid, malic acid, phosphoric acid, sorbic acid, ascorbic acid, adipic acid, gluconic acid, glucono delta-lactone or tartaric acid.

14. The use according to claim 8, wherein the non-wheat flour is rice flour, corn flour, tapioca flour, potato flour, buckwheat flour, amaranth flour, chickpea flour, oat flour, almond flour, rye flour, spelt flour, coconut flour, teff flour, millet flour, faba bean flour, pea flour, sorghum flour, quinoa flour, barley flour, peanut flour, arrowroot flour, banana flour, sunflower seed flour, soy flour, canola flour, rapeseed flour or flaxseed flour.

15. The use according to claim 8, wherein the organic acid is fumaric acid and the non-wheat flour is rice flour.

16. The use according to claim 15, wherein the amount of fumaric acid is 0.125% fwb and the amount of rice flour is 0.75% fwb.

17. The use according to claim 15, wherein the amount of fumaric acid is 0.25% fwb and the amount of rice flour is 0.50% fwb.

18. A method of preparing an artisan bread, the method comprising adding a dough additive to the artisan bread dough, wherein the dough additive comprises an organic acid and a non-wheat flour.

19. The method of claim 18, wherein the artisan bread is a ciabatta bread, a baguette bread, a bolillo bread, a batard bread, a boule bread, a bagel, a stollen bread, a fougasse bread, a focaccia bread, a sourdough bread, a rye bread, a pumpernickel bread, a white bread, a multigrain bread, a panettone bread, a challah bread or a brioche bread.

20. The method of claim 18, wherein the method comprises a preferment process or a straight-dough process.
